(19) United States
(12) Patent Application Publication
(10) Pub. No.: US 2025/0375816 A1
(43) Pub. Date: Dec. 11, 2025

(54) METHOD FOR PRODUCING TURBINE COMPONENT

(71) Applicant: MITSUBISHI HEAVY INDUSTRIES, LTD., Tokyo (JP)

(72) Inventors: Saki MATSUO, Tokyo (JP); Shuji TANIGAWA, Tokyo (JP); Ryuta ITO, Tokyo (JP)

(21) Appl. No.: 18/874,796

(22) PCT Filed: May 30, 2023
(86) PCT No.: PCT/JP2023/020018

§ 371 Date: Dec. 13, 2024

(30) Foreign Application Priority Data
Jun. 22, 2022 (JP) 2022-100155

(51) Int. Cl. B22F 10/28; B22F 10/64; B22F 10/66; B33Y 10/00; B33Y 40/20; B33Y 80/00; F01D 25/00

(52) U.S. Cl. CPC B22F 10/28; B22F 10/64; B22F 10/66; B33Y 10/00; B33Y 40/20; B33Y 80/00; F01D 25/00; B22F 2998/10; F05D 2230/50

(57) ABSTRACT

A method for producing a turbine component including: a shaping step in which, metal powder is bonded together and solidified to form an additively manufactured object having inner passages and discharge passages communicating with the inner passages; and a powder removal step in which unnecessary metal powder remaining in the inner passages is removed. The inner passages have introduction openings that are open in outer surfaces of the additively manufactured object excluding the base-facing surface, which is the outer surface facing the base plate. The discharge passages have discharge openings that are open in the plurality of outer surfaces excluding the base-facing surface. In the powder removal step, a gas is introduced through the introduction openings of the inner passages into the inner passages and the powder remaining in the inner passages is discharged through the discharge openings of the discharge passages together with the gas.

### TECHNICAL FIELD

The present disclosure relates to a method for producing a turbine component forming a turbine.

Priority is claimed on Japanese Patent Application No. 2022-100155, filed on Jun. 22, 2022, the content of which is incorporated herein by reference.

### BACKGROUND ART

Many turbine components forming a turbine have a three-dimensional complicated shape. Therefore, in recent years, a method for producing the turbine component by using a laminate-shaping method has been studied.

As a method for producing a component or the like by using the laminate-shaping method, for example, a method disclosed in PTL 1 below is used. In this method, a laminate printed article which becomes the component or the like is formed by fusing and solidifying a metal powder while distributing the metal powder on a base plate. This laminate printed article has a plurality of outer surfaces and internal passages present inside the plurality of outer surfaces. The internal passage has two openings which are open on a base facing surface facing the base plate in the plurality of outer surfaces. After the laminate printed article is formed, the metal powder remains inside the internal passage. Therefore, according to this method, after the laminate printed article is formed on the base plate, first, the base plate is penetrated to form an inlet hole communicating with one opening of the two openings of the internal passage, and the base plate is penetrated to form an outlet hole communicating with the other opening of the two openings of the internal passage. Then, compressed air or the like is introduced from the inlet hole of the base plate, and the metal powder is discharged into the internal passage from the outlet hole of the base plate, together with the compressed air or the like.

### CITATION LIST

### Patent Literature

[PTL 1] Japanese Unexamined Patent Application Publication No. 2004-027328

### SUMMARY OF INVENTION

### Technical Problem

In the method disclosed in PTL 1 above, the holes are opened in the base plate. Therefore, the base plate cannot be used again, and there is a problem in that production costs increase.

Therefore, an object of the present disclosure is to provide a method for producing a turbine component, which can suppress production costs while removing a residual powder inside an internal passage.

### Solution to Problem

According to one aspect of the invention for achieving the object, there is provided a method for producing a turbine component. The method includes a printed article forming step of forming a laminate printed article having a plurality of outer surfaces, an internal passage present inside the plurality of outer surfaces, and a discharge passage communicating with the internal passage, by fusing and solidifying a metal powder while distributing the metal powder on a base plate, a powder removal step of removing a residual powder which is an unnecessary metal powder remaining inside the internal passage, a heat treatment step of performing heat treatment on the laminate printed article by heating the laminate printed article on the base plate, after the powder removal step, a plate detachment step of detaching the laminate printed article from the base plate, after the heat treatment step, and a finishing step of completing the turbine component by using the laminate printed article detached from the base plate. The internal passage of the laminate printed article formed in the printed article forming step has an introduction opening which is open on an introduction opening surface which is one of outer surfaces excluding a base facing surface which is an outer surface facing the base plate in the plurality of outer surfaces. The discharge passage of the laminate printed article formed in the printed article forming step has a discharge opening which is open on a discharge opening surface which is at least one of the outer surfaces excluding the base facing surface in the plurality of outer surfaces. In the powder removal step, a fluid is introduced into the internal passages from the introduction opening of the internal passage, and the residual powder inside the internal passages is discharged from the discharge opening of the discharge passage together with the fluid.

In the present aspect, the powder removal step is performed after the printed article forming step and before the heat treatment step. Therefore, it is possible to remove the residual powder which is the unnecessary metal powder remaining inside the internal passage of the laminate printed article. Furthermore, in the present aspect, in the plurality of outer surfaces of the laminate printed article, the introduction opening through which a fluid such as a gas is introduced into the internal passage in the powder removal step, and the discharge opening through which the residual powder is discharged together with the fluid in the powder removal step are formed on the outer surface excluding the base facing surface which is the outer surface facing the base plate. Therefore, it is not necessary to process the base plate when the powder is removed. Therefore, in the present aspect, the base plate can be reused, and production costs of the turbine component can be reduced.

### Advantageous Effects of Invention

According to one aspect of the present disclosure, the production costs of the turbine component can be suppressed, while the residual powder inside the internal passage is removed.

### BRIEF DESCRIPTION OF DRAWINGS

FIG. 1 is a schematic cross-sectional view of a gas turbine according to an embodiment of the present invention.

FIG. 2 is a cross-sectional view of a main part of the gas turbine according to the embodiment of the present invention.

FIG. 3 is a perspective view of a ring segment which is a turbine component in the embodiment of the present invention.

FIG. 4 is a cross-sectional view taken along line IV-IV in FIG. 3.

FIG. 5 is a flowchart illustrating a production procedure of the turbine component according to the embodiment of the present invention.

FIG. 6 is a perspective view of a laminate printed article in one embodiment according to the present invention.

FIG. 7 is a cross-sectional view taken along line VII-VII in FIG. 6.

FIG. 8 is a view of an arrow VIII in FIG. 6.

FIG. 9 is a view for describing a powder removal step according to the embodiment of the present invention.

FIG. 10 is a view for describing an opening closing step in the embodiment according to the present invention.

FIG. 11 is a view for describing a discharge passage forming portion removal step in the embodiment according to the present invention.

FIG. 12 is a view for describing a discharge opening closing step of closing a first discharge opening in a modification example of the embodiment according to the present invention.

FIG. 13 is a view for describing a discharge opening closing step of closing a second discharge opening in a modification example of the embodiment according to the present invention.

### DESCRIPTION OF EMBODIMENTS

Hereinafter, embodiments of a turbine component according to the present disclosure and a turbine including the turbine component will be described in detail with reference to the drawings.

### [Embodiment of Turbine]

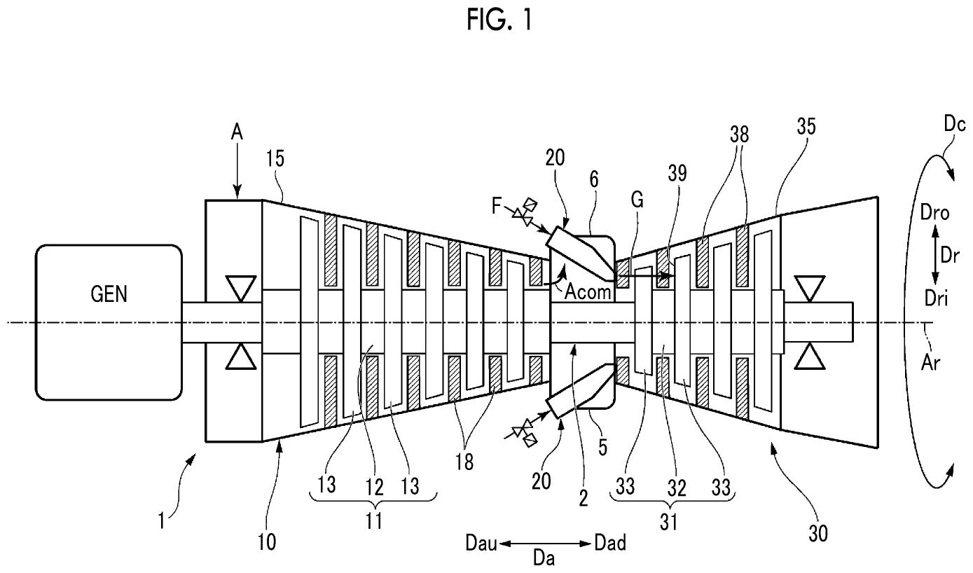

An embodiment of a turbine will be described with reference to FIGS. 1 to 4.

As illustrated in FIG. 1, a turbine in the present embodiment is a gas turbine 1. The gas turbine 1 includes a compressor 10 that compresses outside air A to generate compressed air Acom, a combustor 20 that combusts a fuel F from a fuel supply source in the compressed air Acom to generate a combustion gas G, and a turbine 30 driven by the combustion gas G.

The compressor 10 includes a compressor rotor 11 that rotates around an axis Ar; a compressor casing 15 that covers the compressor rotor 11; and a plurality of stator vane rows 18. The turbine 30 includes a turbine rotor 31 that rotates around the axis Ar; a turbine casing 35 that covers the turbine rotor 31; and a plurality of stator vane rows 38. Hereinafter, an extending direction of the axis Ar will be referred to as an axial direction Da, a circumferential direction around the axis Ar will be simply referred to as a circumferential direction Dc, and a direction perpendicular to the axis Ar will be referred to as a radial direction Dr. In addition, one side in the axial direction Da will be referred to as an axial upstream side Dau, and a side opposite thereto will be referred to as an axial downstream side Dad. In addition, a side closer to the axis Ar in the radial direction Dr will be referred to as a radial inner side Dri, and a side opposite thereto will be referred to as a radial outer side Dro.

The compressor 10 is disposed on the axial upstream side Dau with respect to the turbine 30.

The compressor rotor 11 and the turbine rotor 31 are located on the same axis Ar, and are connected to each other to form a gas turbine rotor 2. For example, a rotor of a generator GEN is connected to the gas turbine rotor 2. The gas turbine 1 further includes an intermediate casing 6. The intermediate casing 6 is disposed between the compressor casing 15 and the turbine casing 35 in the axial direction Da. The compressor casing 15, the intermediate casing 6, and the turbine casing 35 are connected to each other to form a gas turbine casing 5.

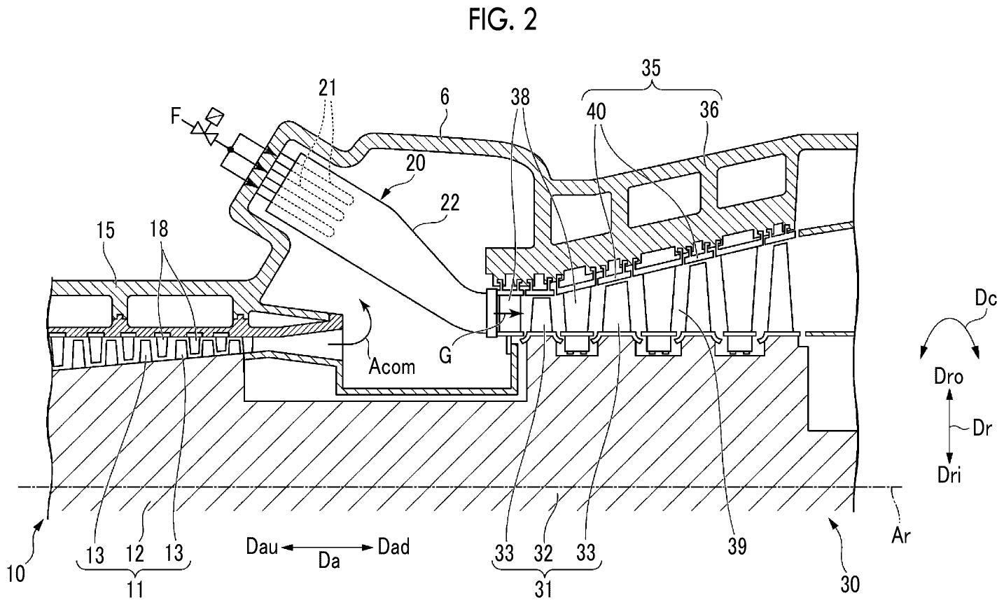

As illustrated in FIGS. 1 and 2, the compressor rotor 11 includes a rotor shaft 12 extending in the axial direction Da around the axis Ar, and a plurality of rotor blade rows 13 attached to the rotor shaft 12. The plurality of rotor blade rows 13 are aligned in the axial direction Da. Each of the rotor blade rows 13 includes a plurality of rotor blades aligned in the circumferential direction Dc. One stator vane row 18 of the plurality of stator vane rows 18 is disposed on the axial downstream side Dad of each of the plurality of rotor blade rows 13. Each of the stator vane rows 18 is provided inside the compressor casing 15. Each of the stator vane rows 18 includes a plurality of stator vanes aligned in the circumferential direction Dc.

The turbine rotor 31 includes a rotor shaft 32 extending in the axial direction Da around the axis Ar, and a plurality of rotor blade rows 33 attached to the rotor shaft 32. The plurality of rotor blade rows 33 are aligned in the axial direction Da. Each of the rotor blade rows 33 includes a plurality of rotor blades aligned in the circumferential direction De. One stator vane row 38 of the plurality of stator vane rows 38 is disposed on the axial upstream side Dau of each of the plurality of rotor blade rows 33. Each of the stator vane rows 38 is provided inside the turbine casing 35. Each of the stator vane rows 38 includes a plurality of stator vanes aligned in the circumferential direction Dc.

An annular space between an outer peripheral side of the rotor shaft 32 and an inner peripheral side of the turbine casing 35, where the rotor blade row 33 and the stator vane row 38 are disposed in the axial direction Da, forms a combustion gas flow path 39 through which the combustion gas G from the combustor 20 flows. The combustion gas flow path 39 has an annular shape around the axis Ar, and is long in the axial direction Da.

As illustrated in FIG. 2, the turbine casing 35 includes a turbine casing body 36 and a plurality of ring segments 40. The ring segment 40 is located on the radial outer side Dro of the rotor blade row 33, and faces the rotor blade row 33 in the radial direction Dr. The ring segment 40 defines a portion of an edge of the combustion gas flow path 39 on the radial outer side Dro at a position in the axial direction Da where the rotor blade row 33 exists. The turbine casing body 36 has a tubular shape around the axis Ar to surround an outer periphery of the turbine rotor 31. The plurality of stator vane rows 38 and the plurality of ring segments 40 are attached to an inner peripheral side portion of the turbine casing body 36.

The combustor 20 is attached to the intermediate casing 6. As illustrated in FIG. 2, the combustor 20 includes a transition piece (or combustion tube) 22 in which the fuel F is internally combusted, and a plurality of burners 21 that inject the fuel into the transition piece 22.

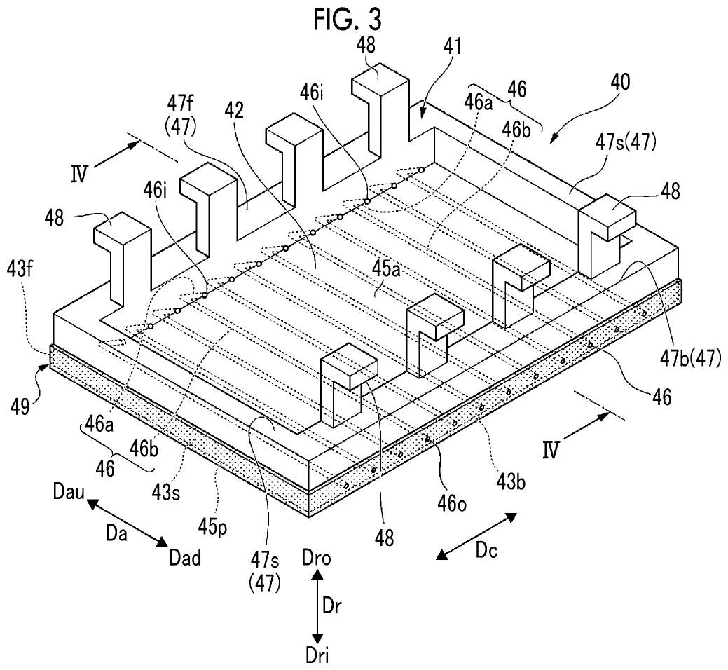

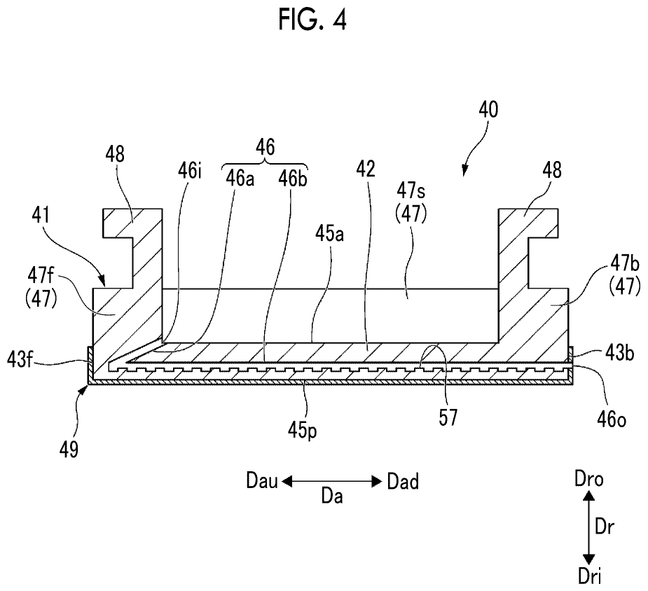

As illustrated in FIGS. 3 and 4, the above-described ring segment 40 includes a base material 41 and a thermal barrier coating layer 49 formed on a portion of a surface of the base material 41. For example, the base material 41 is formed of a nickel-based alloy. The thermal barrier coating layer 49 includes a bond coating layer formed on the surface of the base material 41, and a top coating layer formed on the surface of the bond coating layer. For example, the bond coating layer is formed of metal such as CoNiCrAlY. In addition, for example, the top coating layer is formed of ZrO2-based ceramic.

The base material 41 includes a plate-shaped ring segment body 42 spreading in the circumferential direction De and the axial direction Da, a peripheral wall 47 extending from a peripheral edge of the ring segment body 42 to the radial outer side Dro, and a plurality of hooks 48 formed on a portion of the peripheral wall 47. The ring segment body 42 has a front end surface 43f, a rear end surface 43b, a pair of side end surfaces 43s, a gas path side surface 45p, and a counter-gas path side surface 45a. The front end surface 43f faces the axial upstream side Dau. The rear end surface 43b is in a back-to-back relationship with the front end surface 43f, and faces the axial downstream side Dad. The pair of side end surfaces 43s face the circumferential direction Dc, and are in a back-to-back relationship with each other. The gas path side surface 45p faces the radial inner side Dri. The counter-gas path side surface 45a faces the radial outer side Dro. The peripheral wall 47 includes a front wall 47f, a rear wall 47b, and a pair of side walls 47s. The front wall 47f is formed along the front end surface 43f of the ring segment body 42. The rear wall 47b is formed along the rear end surface 43b of the ring segment body 42. The front wall 47f and the rear wall 47b face each other at an interval from each other in the axial direction Da. One side wall 47s of the pair of side walls 47s is formed along one side end surface 43s of the pair of side end surfaces 43s of the ring segment body 42. The other side wall 47s of the pair of side walls 47s is formed along the other side end surface 43s of the pair of side end surfaces 43s of the ring segment body 42. The pair of side walls 47s face each other at an interval from each other in the circumferential direction Dc. In the plurality of hooks 48, some hooks 48 are formed on the radial outer side Dr of the front wall 47f, and the other hooks 48 are formed on the radial outer side Dr of the rear wall 47b. Each of the hooks 48 has a portion extending to the radial outer side Dro, and a portion extending in the axial direction Da from an end of the radial outer side Dro of the portion. The hooks 48 play a role of attaching the ring segment 40 to the turbine casing body 36.

The ring segment body 42 further includes a plurality of cooling air passages 46. Each of the cooling air passages 46 includes an introduction passage 46a and a main passage 46b. The introduction passage 46a gradually extends toward the radial inner side Dri from a position on a boundary between the counter-gas path side surface 45a of the ring segment body 42 and the front wall 47f as introduction passage 46a is directed toward the axial upstream side Dau. The introduction passage 46a includes an air inlet 46i which is open at a boundary between the counter-gas path side surface 45a of the ring segment body 42 and the front wall 47f. The main passage 46b communicates with the introduction passage 46a at a position of an end of the radial inner side Dri, which is an end on the axial upstream side Dau of the introduction passage 46a. The main passage 46b extends toward the axial downstream side Dad from a communication position with the introduction passage 46a. The main passage 46b includes an air outlet 460 which is open on the rear end surface 43b of the ring segment body 42. On a surface for defining the main passage 46b, a portion on the side of the gas path side surface 45p is formed such that an undulating shape is repeated in the extending direction of the main passage. That is, a turbulator 57 is formed on the surface for defining the main passage 46b.

The thermal barrier coating layer 49 is formed on the gas path side surface 45p, the front end surface 43f, the rear end surface 43b, and the pair of side end surfaces 43s of the ring segment body 42.

All of the components forming the gas turbine 1 described above are turbine components. In addition, in the turbine components, a component in contact with a high-temperature combustion gas is a turbine high-temperature component. The turbine high-temperature component includes a component forming the combustor 20, the stator vane of the turbine 30, the rotor blade of the turbine 30, and the ring segment 40.

### [Embodiment of Method for Producing Turbine Component]

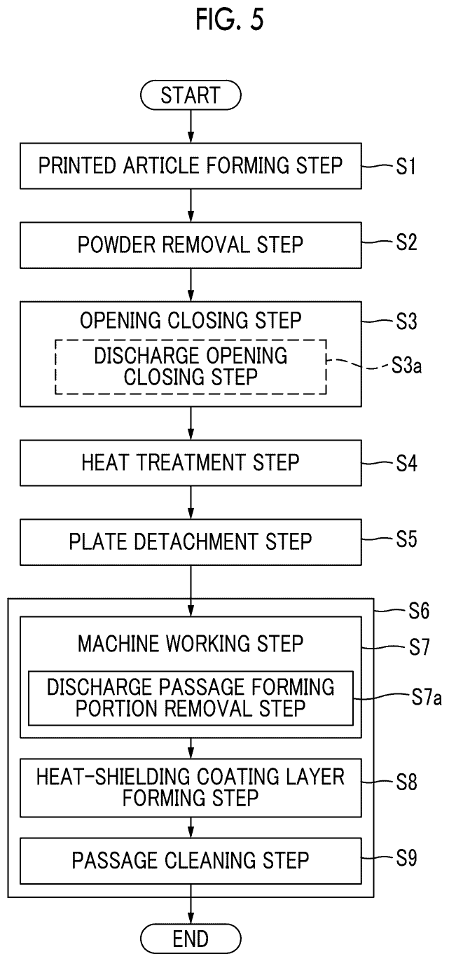

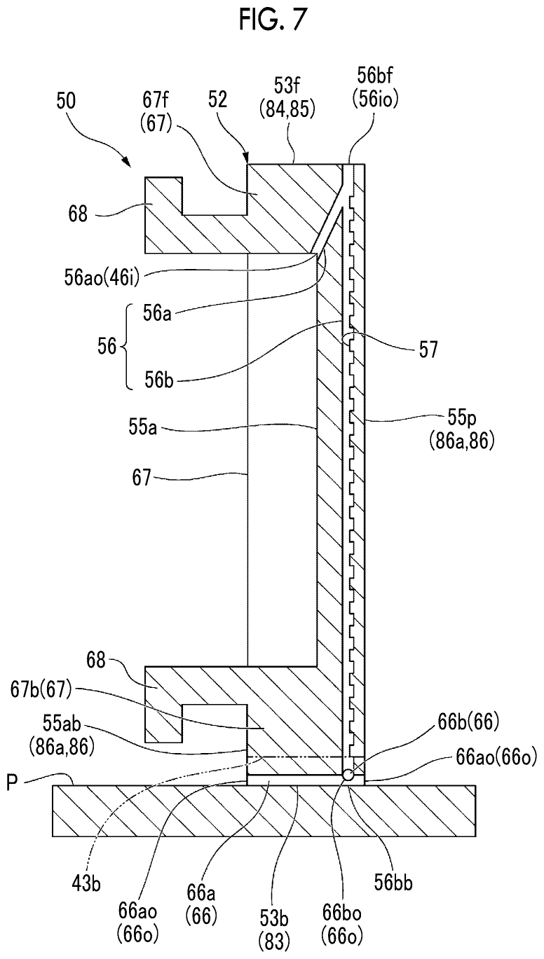

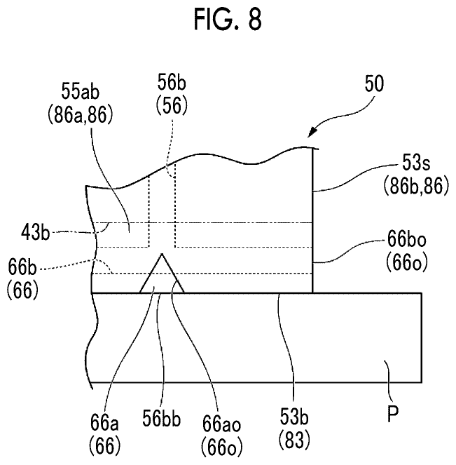

Hereinafter, a method for producing the ring segment 40, which is one of the turbine components, will be described with reference to FIGS. 5 to 11.

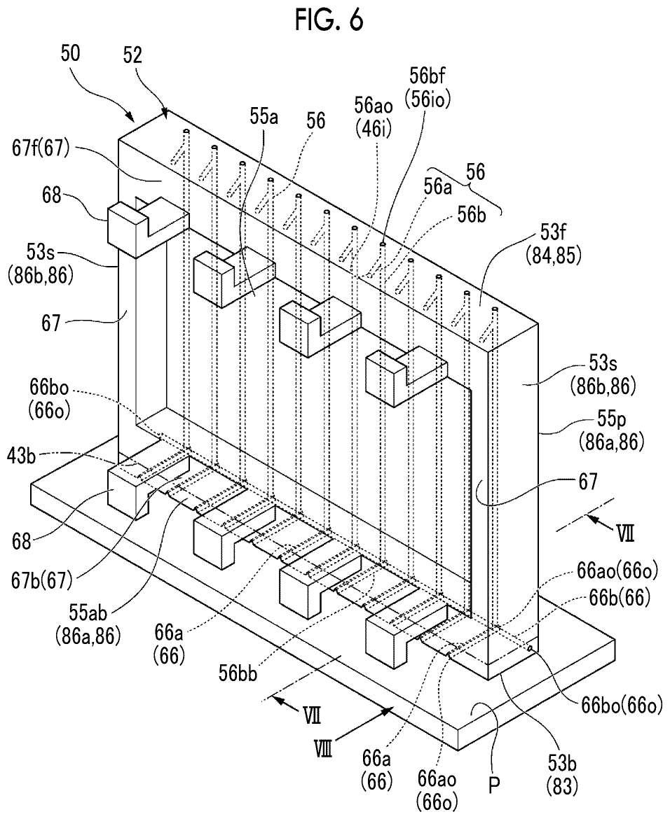

In producing the ring segment 40, as illustrated in a flowchart in FIG. 5, first, a laminate printed article is formed (printed article forming step S1). In the present embodiment, the laminate printed article is formed by using a powder bed fusion (PBF) method. In the PBF method, as illustrated in FIG. 6, a metal powder for forming a laminate printed article 50 is distributed on a base plate P, a predetermined region of a layer of the metal powder is irradiated with high-density energy beam on the base plate P, and the metal powder inside the region is melted. Then, molten metal inside this region is rapidly cooled and solidified to form a metal solidified layer having a predetermined shape. In the PBF method, the metal solidified layer having the predetermined shape is repeatedly formed on the metal solidified layer by using the above-described method, and the laminate printed article 50 having a predetermined three-dimensional shape is formed.

The PBF method described above includes a selective laser melting (SLM) method in which the metal powder is melted with laser light and the metal powder is fused and solidified, and an electron beam melting (EBM) (electron beam laminate printing) method in which the metal powder is melted with an electron beam and the metal powder is fused and solidified. In the present embodiment, the SLM method is adopted. However, in the present embodiment, the EBM method may be adopted.

This laminate printed article 50 becomes the base material 41 of the ring segment 40 described above. Therefore, in the present embodiment, the metal powder forming the laminate printed article 50 is a powder of a nickel-based alloy. As illustrated in FIGS. 6 to 8, the laminate printed article 50 includes a main body portion 52 which becomes the ring segment body 42, a peripheral wall portion 67 which becomes the peripheral wall 47 of the ring segment 40, and a hook portion 68 which becomes the plurality of hooks 48 of the ring segment 40. As in the ring segment body 42, the main body portion 52 has a front end surface 53f, a rear end surface 53b, a pair of side end surfaces 53s, a gas path side surface 55p, and a counter-gas path side surface 55a. The front end surface 53f and the rear end surface 53b are in a back-to-back relationship with each other. The pair of side end surfaces 53s are in a back-to-back relationship with each other. The gas path side surface 55p and the counter-gas path side surface 55a are in a back-to-back relationship with each other. The gas path side surface 55p and the counter-gas path side surface 55a spread in a direction having a direction component perpendicular to a spreading direction of the front end surface 53f, a spreading direction of the rear end surface 53b, and a spreading direction of the pair of side end surfaces 53s. Both the pair of side end surfaces 53s connect the front end surface 53f and the rear end surface 53b, and connect the gas path side surface 55p and the counter-gas path side surface 55a.

The main body portion 52 of the laminate printed article 50 further includes a plurality of internal passages 56 and a plurality of discharge passages 66. The internal passage 56 extends in the direction having the direction component perpendicular to the base plate P, in other words, in an up-down direction. The internal passage 56 forms the cooling air passage 46 of the ring segment 40. Therefore, the internal passage 56 includes an auxiliary internal passage 56a which becomes the introduction passage 46a of the cooling air passage 46, and a main internal passage 56b which becomes the main passage 46b of the cooling air passage 46. The auxiliary internal passage 56a gradually extends toward the gas path side surface 55p from a position on the boundary between the counter-gas path side surface 55a of the main body portion 52 and the front wall portion 67f in the peripheral wall portion 67 as auxiliary internal passage 56a is directed toward the front end surface 53f. The auxiliary internal passage 56a includes a counter-gas path side opening 56ao which is open at the boundary between the counter-gas path side surface 55a of the main body portion 52 and the front wall portion 67f. The counter-gas path side opening 56ao forms the air inlet 46i of the cooling air passage 46. The main internal passage 56b extends from the front end surface 53f to the rear end surface 53b of the laminate printed article 50. The main internal passage 56b includes a front opening 56bf which is open on the front end surface 53f of the laminate printed article 50, and a rear opening 56bb which is open on the rear end surface 53b of the laminate printed article 50. The main internal passage 56b communicates with the auxiliary internal passage 56a at a position of an end of the side of the gas path side surface 55p, which is an end on the side of the front end surface 53f of the auxiliary internal passage 56a. On a surface for defining the main internal passage 56b, a portion on the side of the gas path side surface 55p is formed such that an undulating shape is repeated in the extending direction of the main internal passage 56b. That is, the turbulator 57 is formed on the surface for defining the main internal passage 56b.

The rear end surface 53b of the main body portion 52 forms a base facing surface 83 facing the base plate P. In addition, the front end surface 53f of the main body portion 52 forms a base opposite surface 84, and forms an introduction opening surface 85 on which the front opening 56bf of the main internal passage 56b is formed. In addition, the front opening 56bf of the main internal passage 56b forms an introduction opening 56i0.

In the plurality of discharge passages 66, some of the plurality of discharge passages 66 form a first discharge passage 66a, and the other discharge passages 66 form a second discharge passage 66b. As illustrated in FIGS. 6 to 8, both the first discharge passage 66a and the second discharge passage 66b communicate with the internal passage 56 in an end portion closer to the base plate in the internal passage 56, and extend along the base plate P. Here, the end portion closer to the base plate in the internal passage 56 is a portion from an end on a side closest to the base plate P in the internal passage 56 to a distance of 1/10 of a total length of the internal passage 56, for example.

Each of the plurality of first discharge passages 66a communicates with one internal passage 56 of the plurality of internal passages 56 in the end on the side closest to the base plate P in the one internal passage 56. The first discharge passage 66a is a groove recessed upward from the base facing surface 83 and extending from a communication position with the internal passage 56 to a rear counter-gas path side surface 55ab which is a surface of the gas path side surface 55p and the rear wall portion 67b and is a surface on a counter path side. In other words, the first discharge passage 66a is a groove recessed upward from the base facing surface 83, extending from the gas path side surface 55p to the rear counter-gas path side surface 55ab of the rear wall portion 67b, and communicating with the one internal passage 56 in an intermediate portion. The first discharge passage 66a includes a first discharge opening 66ao which is open on the gas path side surface 55p and the rear counter-gas path side surface 55ab, as a discharge opening 660. Therefore, both the gas path side surface 55p and the rear counter-gas path side surface 55ab form a first discharge opening surface 86a serving as a discharge opening surface 86.

The second discharge passage 66b communicates with all of the internal passages 56 in an end portion closer to the base plate in the internal passage 56, at a position closer to a side of the front end surface 53f (base facing surface 83) than a communication position between the first discharge passage 66a and the internal passage 56. The second discharge passage 66b extends from one side end surface 53s of the pair of side end surfaces 53s to the other side end surface 53s, and communicates with all of the internal passages 56 in an intermediate portion thereof. Therefore, the second discharge passage 66b communicates with each of the plurality of first discharge passages 66a. In addition, the second discharge passage 66b extends in a direction different from a direction of the first discharge passage 66a. The second discharge passage 66b includes second discharge openings 66bo which are open on each of the pair of side end surfaces 53s in the main body portion 52, as the discharge openings 660. Therefore, both the pair of side end surfaces 53s of the main body portion 52 form the second discharge opening surfaces 86b, as the discharge opening surfaces 86.

When the laminate printed article 50 having the internal passage 56 is formed by using the PBF method, the metal powder injected in a process of forming the plurality of metal solidified layers on the upper side of the first metal solidified layer reaches an internal passage forming portion in the first metal solidified layer, and the metal powder remains in the internal passage forming portion. In particular, as in the present embodiment, the turbulator 57 is formed on the surface for defining the internal passage 56, and the surface has an undulating shape. Therefore, the metal powder is likely to be accumulated in a recessed portion. This metal powder is an unnecessary metal powder. Therefore, in the present embodiment, after the printed article forming step S1 is completed, the powder removal step S2 of removing the residual powder which is the unnecessary metal powder remaining inside the internal passage 56 is performed.

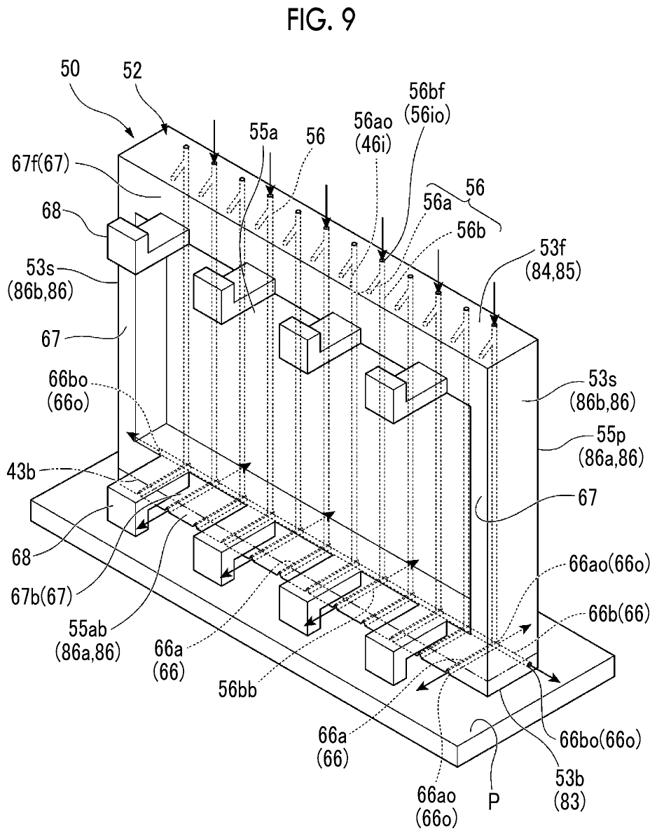

In the powder removal step S2, as illustrated in FIG. 9, the fluid is introduced into the internal passage 56 from the introduction opening 56io which is the front opening S6bf of the internal passage 56, and the residual powder inside the internal passage 56 is discharged together with the fluid from the two first discharge openings 66ao of the first discharge passage 66a and the two second discharge openings 66bo of the second discharge passage 66b. Here, the fluid introduced to discharge the residual powder may be a liquid such as water in addition to a gas such as air or nitrogen. In addition, examples of the method for introducing and discharging the fluid include a method for injecting the gas or the liquid into the internal passage in the air, a method for injecting the gas or the liquid into the internal passage in a state where the laminate printed article is immersed in the liquid, a method for suctioning the fluid introduced from the internal passage from the discharge passage, and the like. In addition, the fluid may be introduced from the discharge passage, in addition to a case where the fluid is introduced from the internal passage.

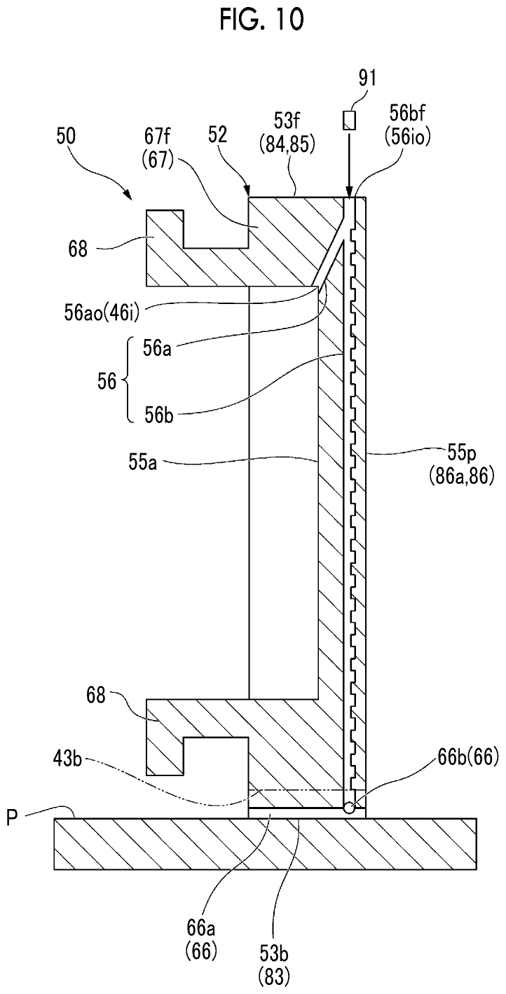

When the powder removal step S2 is completed, as illustrated in FIG. 10, the front opening 56bf of the internal passage 56 is closed (opening closing step S3). In the opening closing step S3, the introduction opening 56io which is the front opening 56bf is closed by a lid 91 made of a nickel-based alloy which is the same metal as the metal for forming the laminate printed article 50, and the lid 91 is welded to the laminate printed article 50.

In some cases, internal stress may be generated in the laminate printed article 50 on the base plate P. In a state where the internal stress is generated, the laminate printed article 50 may deform when the laminate printed article 50 is cut out from the base plate P. In addition, a component exposed to a high-temperature combustion gas, such as the turbine component of the present embodiment, needs to have a long high-temperature creep life. Therefore, in the present embodiment, after the powder removal step S2, the laminate printed article 50 on the base plate P is heated to reduce the internal stress generated in the laminate printed article 50 and to lengthen the high-temperature creep life, and the laminate printed article 50 is subjected to heat treatment (heat treatment step S4).

In the heat treatment step S4, for example, the laminate printed article 50 is heated to a temperature of approximately 1,000° C. for several hours. A heat treatment time and a heating temperature are appropriately set depending on a component amount or the like of a metal element forming the laminate printed article 50. In the heat treatment step S4, the laminate printed article 50 is heated to the temperature of approximately 1,000° C. Therefore, even when the unnecessary metal powder remains inside the internal passage 56 of the laminate printed article 50, the metal powder may be melted, thereby causing a possibility that the melted metal powder is fixed and attached to an inner surface of the internal passage 56. Therefore, it is necessary to perform the heat treatment step S4 after the opening closing step S3.

When the heat treatment step S4 is completed, the laminate printed article 50 is cut out from the base plate P (plate detachment step S5).

When the plate detachment step S5 is completed, various processes are performed on the laminate printed article 50 separated from the base plate P, and the ring segment 40 as the turbine component is completed (finishing step S6).

Various processes performed in the finishing step S6 are different depending on a type of the turbine component. In the present embodiment, in the finishing step S6, a machine working process, a forming process of the thermal barrier coating layer 49, and a passage cleaning process are performed. In other words, in the finishing step S6, a machine working step S7, a thermal barrier coating layer forming step S8, and a passage cleaning step S9 are performed.

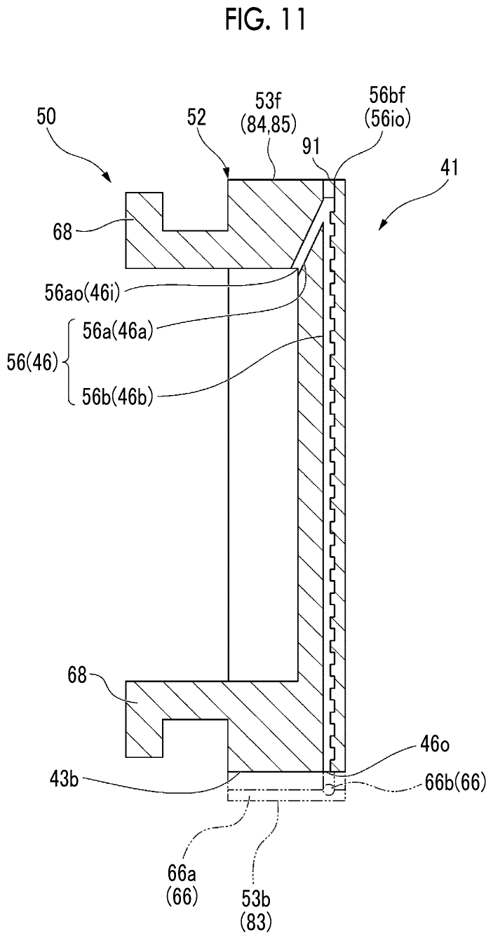

In the machine working step S7, the laminate printed article 50 is subjected to machine working, and an outer surface of the laminate printed article 50 is finished. Through the machine working process, the base material 41 of the ring segment 40 is completed. In the machine working process, a discharge passage forming portion removal step S7a of removing a portion including the base facing surface 83, the first discharge passage 66a, and the second discharge passage 66b in the laminate printed article 50 is performed. Since the discharge passage forming portion removal step S7a is performed, as illustrated in FIG. 11, the rear end surface 43b in the base material 41 of the ring segment 40 is completed, and the air outlet 460 of the cooling air passage 46 which is open on the rear end surface 43b of the base material 41 is completed.

In the thermal barrier coating layer forming step S8, the thermal barrier coating layer 49 is formed in a portion on a surface of the base material 41 of the ring segment 40 completed in the machine working step S7. Specifically, as illustrated in FIGS. 3 and 4, the thermal barrier coating layer 49 is formed on the gas path side surface 45p, the front end surface 43f, the rear end surface 43b, and the pair of side end surfaces 43s of the ring segment body 42 which is a portion of the base material 41. In forming the thermal barrier coating layer 49, first, for example, the metal powder such as CoNiCrAlY is thermally sprayed onto the surface of the base material 41, and a bond coating layer is formed on the surface of the base material 41. Next, for example, a ZrO2-based ceramic powder is thermally sprayed onto the bond coating layer, and a top coating layer is formed on the bond coating layer.

As described above, in the thermal barrier coating layer forming step S8, the metal powder or the ceramic powder is used. Therefore, the powders enter the cooling air passage 46 from the air outlet 460 of the cooling air passage 46. Therefore, in the present embodiment, the passage cleaning step S9 of removing the powder entering the cooling air passage 46 is performed after the thermal barrier coating layer forming step S8.

As described above, the ring segment 40 serving as the turbine component is completed. In addition, when necessary, an accessory attachment step of attaching an accessory to the base material 41 may be added after the machine working step S7.

As described above, in the present embodiment, the powder removal step S2 is performed after the printed article forming step S1 and before the heat treatment step S4. Therefore, it is possible to remove the residual powder which is the unnecessary metal powder remaining inside the internal passage 56 of the laminate printed article 50. In addition, in the present embodiment, the plurality of discharge passages 66 communicating with the internal passage 56 are formed. Therefore, the residual powder inside the internal passage 56 can be efficiently discharged. Moreover, in the present embodiment, the first discharge passage 66a and the second discharge passage 66b extend in mutually different directions, and communicate with each other. Therefore, the residual powder inside the internal passage 56 can be efficiently discharged from this viewpoint as well.

Furthermore, in the present embodiment, the introduction opening 56io through which the fluid is introduced into the internal passage 56 in the powder removal step S2 and the discharge opening 660 through which the residual powder is discharged together with the fluid in the powder removal step S2 are formed on the outer surface excluding the base facing surface 83 which is the outer surface facing the base plate P in the plurality of outer surfaces of the laminate printed article 50. Therefore, it is not necessary to process the base plate P when the powder is removed. Therefore, in the present embodiment, the base plate P can be reused, and the production costs of the turbine component can be reduced.

In addition, in the present embodiment, the discharge passage forming portion removal step S7a is performed. Therefore, it is possible to produce the turbine component having no discharge passage 66.

### Modification Example

Any of the discharge passages 66 in the above-described embodiment has two openings. However, only one opening of the discharge passage 66 may be provided.

In the above-described embodiment, the discharge passage 66 includes the first discharge passage 66a and the second discharge passage 66b. However, only one discharge passage 66 in the first discharge passage 66a and the second discharge passage 66b may be provided.

In the above-described embodiment, the main internal passage 56b formed in the printed article forming step S1 includes the front opening 56bf which is open on the front end surface 53f serving as the base opposite surface 84. However, the main internal passage 56b formed in the printed article forming step S1 does not need to have the front opening 56bf. In this case, the counter-gas path side opening 56ao of the auxiliary internal passage 56a communicating with the main internal passage 56b is set as the introduction opening, and in the powder removal step S2, the gas is introduced into the internal passage 56 from the introduction opening. Therefore, in this case, the counter-gas path side opening 56ao of the auxiliary internal passage 56a forms not only the air inlet 46i of the cooling air passage 46 but also the introduction opening.

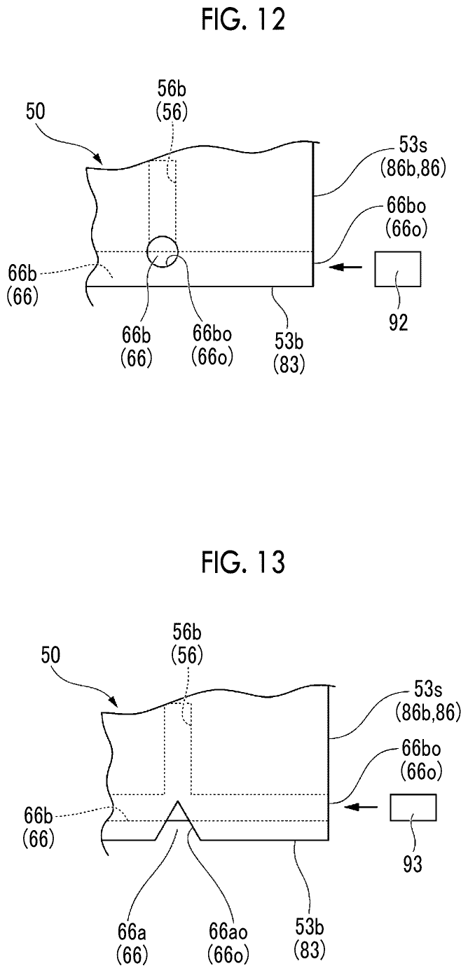

In the above-described embodiment, in the finishing step S6, the discharge passage forming portion removal step S7a of removing the portion including the base facing surface 83, the first discharge passage 66a, and the second discharge passage 66b in the laminate printed article 50 is performed. However, the discharge passage forming portion removal step S7a does not need to be performed, and the first discharge passage 66a and the second discharge passage 66b may remain in the ring segment 40 which is a completed product. In this case, after the powder removal step S2, a discharge opening closing step S3a (refer to FIG. 5) of closing the first discharge opening 66ao of the first discharge passage 66a and the second discharge opening 66bo of the second discharge passage 66b may be performed. In the discharge opening closing step S3a, as illustrated in FIG. 12, the first discharge opening 66ao is closed by the lid 92 made of the nickel-based alloy which is the same metal as the metal for forming the laminate printed article 50, and the lid 92 is welded to the laminate printed article 50. Furthermore, as illustrated in FIG. 13, the second discharge opening 66bo is closed by a lid 93 made of the nickel-based alloy which is the same metal as the metal for forming the laminate printed article 50, and the lid 93 is welded to the laminate printed article 50. Here, both the first discharge opening 66ao and the second discharge opening 66bo are closed, but any one of the openings, for example, only the second discharge opening 66bo may be closed.

In addition, the discharge opening closing step S3a described above and the opening closing step S3 described above are performed after the powder removal step S2, but may be performed after the heat treatment step S4 or the plate detachment step S5. For example, the discharge opening closing step S3a described above and the opening closing step S3 described above may be performed as one step in the finishing step S6. However, when welding is performed in the discharge opening closing step S3a and the opening closing step S3, it is preferable to perform the welding before the heat treatment step S4.

The turbine component of the above-described embodiment is the ring segment 40 of the gas turbine 1. However, when the component having the internal passage 56 is the component, the other high-temperature gas turbine components of the gas turbine 1 may be produced by using the method described above. As described above, the other high-temperature gas turbine components include the component of the combustor, the stator blade of the turbine, the rotor blade of the turbine, and the like. Furthermore, the turbine component is not limited to the component of the gas turbine 1, and for example, may be a component of a steam turbine as long as the turbine component has the internal passage.

The present disclosure is not limited to the embodiment and the modification example which are described above. Various additions, changes, replacements, or partial deletions can be made within the scope not departing from the conceptual idea and the concept of the present invention derived from the contents defined in the scope of the appended claims and the equivalent thereof.

### Additional Notes

The method for producing the turbine component in the above-described embodiment and the modification example is understood as follows, for example.

(1) According to a first aspect, there is provided a method for producing a turbine component. The method includes the printed article forming step S1 of forming the laminate printed article 50 having the plurality of outer surfaces, the internal passage 56 present inside the plurality of outer surfaces, and the discharge passage 66 communicating with the internal passage 56, by fusing and solidifying the metal powder while distributing the metal powder on the base plate P, the powder removal step S2 of removing the residual powder which is the unnecessary metal powder remaining inside the internal passage 56, the heat treatment step S4 of performing the heat treatment on the laminate printed article 50 by heating the laminate printed article 50 on the base plate P, after the powder removal step S2, the plate detachment step S5 of detaching the laminate printed article 50 from the base plate P, after the heat treatment step S4, and the finishing step S6 of completing the turbine component by using the laminate printed article 50 detached from the base plate P. The internal passage 56 of the laminate printed article 50 formed in the printed article forming step S1 has the introduction opening 56io which is open on the introduction opening surface 85 which is one of the outer surfaces excluding the base facing surface 83 which is the outer surface facing the base plate P in the plurality of outer surfaces. The discharge passage 66 of the laminate printed article 50 formed in the printed article forming step S1 has the discharge opening 660 which is open on the discharge opening surface 86 which is at least one of the outer surfaces excluding the base facing surface 83 in the plurality of outer surfaces. In the powder removal step S2, the fluid is introduced into the internal passage 56 from the introduction opening 56io of the internal passage 56, and the residual powder inside the internal passage 56 is discharged together with the fluid from the discharge opening 660 of the discharge passage 66.

In the present aspect, the powder removal step S2 is performed after the printed article forming step S1 and before the heat treatment step S4. Therefore, it is possible to remove the residual powder which is the unnecessary metal powder remaining inside the internal passage 56 of the laminate printed article 50. Furthermore, in the present aspect, the introduction opening 56io through which the fluid such as the gas is introduced into the internal passage 56 in the powder removal step S2 and the discharge opening 660 through which the residual powder is discharged together with the fluid in the powder removal step S2 are formed on the outer surface excluding the base facing surface 83 which is the outer surface facing the base plate P in the plurality of outer surfaces of the laminate printed article 50. Therefore, it is not necessary to process the base plate P when the powder is removed. Therefore, in the present aspect, the base plate P can be reused, and the production costs of the turbine component can be reduced.

(2) As the method for producing the turbine component according to a second aspect, in the method for producing the turbine component according to the first aspect, the discharge passage 66 has the discharge opening 660 which is open on each of two outer surfaces excluding the base facing surface 83 in the plurality of outer surfaces, and both the two outer surfaces form the discharge opening surface 86.

In the present aspect, the discharge passage 66 has two discharge openings 660. Therefore, the residual powder inside the internal passage 56 can be efficiently discharged outward of the internal passage 56.

(3) As the method for producing the turbine component according to a third aspect, in the method for producing the turbine component according to the first or second aspect, in the printed article forming step S1, the plurality of discharge passages 66 communicating with the internal passage 56 are formed.

In the present aspect, the plurality of discharge passages 66 communicating with the internal passage 56 are formed. Therefore, the residual powder inside the internal passage 56 can be efficiently discharged outward of the internal passage 56.

(4) As the method for producing the turbine component according to a fourth aspect, in the method for producing the turbine component according to the third aspect, the first discharge passage 66a and the second discharge passage 66b in the plurality of discharge passages 66 extend in a direction intersecting each other, and communicate with each other.

Compared to when the first discharge passage 66a and the second discharge passage 66b extend in mutually the same direction, the residual powder inside the internal passage 56 can be more efficiently discharged outward of the internal passage 56.

(5) As the method for producing the turbine component according to a fifth aspect, in the method for producing the turbine component according to any one of the first to fourth aspects, at least a portion of the surface for defining the internal passage 56 is formed such that the undulating shapes are repeated in the extending direction of the internal passage 56.

When the surface for defining the internal passage 56 has the undulating shape, the residual powder is likely to be accumulated in the recess. Therefore, when the surface for defining the internal passage 56 has the undulating shape, it is preferable to necessarily perform the powder removal step S2 as in the present aspect.

(6) As the method for producing the turbine component according to a sixth aspect, in the method for producing the turbine component according to any one of the first to fifth aspects, the internal passage 56 has the main internal passage 56b having the introduction opening 56io which is open on the base opposite surface 84 in the back-to-back relationship with the base facing surface 83, and the auxiliary internal passage 56a which is open on the outer surface excluding the base facing surface 83 and the base opposite surface 84 in the plurality of outer surfaces, and which communicates with the main internal passage 56b. After any one step of the powder removal step S2, the heat treatment step S4, and the plate detachment step S5, the opening closing step S3 of closing the introduction opening 56io which is open on the base opposite surface 84 of the main internal passage 56b is performed.

In the present aspect, the introduction opening 56io is closed after the opening closing step S3. Therefore, in the present aspect, it is possible to produce the turbine component having no introduction opening 56io on the base opposite surface 84.

(7) As the method for producing the turbine component according to a seventh aspect, in the method for producing the turbine component according to any one of the first to sixth aspects, the internal passage 56 extends in the direction having the direction component perpendicular to the base plate P. The discharge passage 66 extends in the direction having the direction component parallel to the base plate P.

(8) As the method for producing the turbine component according to an eighth aspect, in the method for producing the turbine component according to the seventh aspect, the discharge passage 66 communicates with the internal passage 56 in the end portion closer to the base plate in the internal passage 56, and extends along the base plate P.

(9) As the method for producing the turbine component according to a ninth aspect, in the method for producing the turbine component according to the eighth aspect, the discharge passage 66 is the groove recessed upward from the base facing surface 83, and extending to the discharge opening surface 86 from the communication position with the internal passage 56.

(10) As the method for producing the turbine component according to a tenth aspect, in the method for producing the turbine component according to the eighth aspect, the discharge passage 66 extends from the communication position with the internal passage 56 to the discharge opening surface 86 in the portion separated upward from the base facing surface 83, which is the portion closer to the base plate in the laminate printed article 50.

(11) As the method for producing the turbine component according to an eleventh aspect, in the method for producing the turbine component according to the eighth aspect, the discharge passage 66 includes the first discharge passage 66a and the second discharge passage 66b. The first discharge passage 66a is the groove communicating with the internal passage 56 in the end of the side of the base plate P of the internal passage 56, recessed upward from the base facing surface 83, and extending from the communication position with the internal passage 56 to the first discharge opening surface 86a serving as the discharge opening surface 86. The second discharge passage 66b communicates with the internal passage 56 at the portion which is the portion close to the base plate P in the internal passage 56 and which is separated further upward from the base plate P than the first discharge passage 66a, and extends from the communication position with the internal passage 56 to the second discharge opening surface 86b serving as the discharge opening surface 86. The second discharge opening surface 86b is the surface excluding the base facing surface 83 and the first discharge opening surface 86a in the plurality of outer surfaces. Both the first discharge opening surface 86a and the second discharge opening surface 86b are outer surfaces connected to the edge of the base facing surface 83 in a plurality of the outer surfaces.

In the present aspect, the plurality of discharge passages 66 communicating with the internal passage 56 are formed. Therefore, the residual powder inside the internal passage 56 can be efficiently discharged outward of the internal passage 56. Moreover, in the present aspect, the first discharge passage 66a and the second discharge passage 66b extend in mutually different directions, and communicate with each other. Therefore, the residual powder inside the internal passage 56 can be efficiently discharged outward of the internal passage 56 from this viewpoint as well.

(12) As the method for producing the turbine component according to a twelfth aspect, in the method for producing the turbine component according to any one of the eighth to eleventh aspects, the finishing step S6 includes the discharge passage forming portion removal step S7a of removing the portion including the base facing surface 83 and the discharge passage 66 in the laminate printed article 50.

In the present aspect, it is possible to produce the turbine component having no discharge passage 66.

(13) As the method for producing the turbine component according to a thirteenth aspect, in the method for producing the turbine component according to any one of the first to eleventh aspects, after any one step of the powder removal step S2, the heat treatment step S4, and the plate detachment step S5, the discharge opening closing step S3a of closing the discharge opening 660 of the discharge passage 66 is performed.

In the present aspect, even when the discharge passage 66 remains, it is possible to produce the turbine component in which the discharge passage 66 does not function as the discharge passage 66.

(14) As the method for producing the turbine component according to a fourteenth aspect, in the method for producing the turbine component according to any one of the first to thirteenth aspects, the finishing step S6 includes the thermal barrier coating layer forming step S8 of forming the thermal barrier coating layer 49 on at least some outer surfaces in the plurality of outer surfaces of the laminate printed article 50.

### INDUSTRIAL APPLICABILITY

According to one aspect of the present disclosure, the production costs of the turbine component can be suppressed, while the residual powder inside the internal passage is removed.

### REFERENCE SIGNS LIST

1: gas turbine
2: gas turbine rotor
5: gas turbine casing
6: intermediate casing
10: compressor
11: compressor rotor
12: rotor shaft
13: rotor blade row
15: compressor casing
18: stator vane row
20: combustor
21: burner
22: transition piece (or combustion tube)
30: turbine
31: turbine rotor
32: rotor shaft
33: rotor blade row
35: turbine casing
36: turbine casing body
38: stator vane row
39: combustion gas flow path
40: ring segment
41: base material
42: ring segment body
43f: front end surface
43b: rear end surface
43s: side end surface
45p: gas path side surface
45a: counter-gas path side surface
46: cooling air passage
46i: air inlet
46o: air outlet
46a: introduction passage
46b: main passage
47: peripheral wall
47f: front wall
47b: rear wall
47s: side wall
48: hook
49: thermal barrier coating layer
50: laminate printed article
52: main body portion
53f: front end surface
53b: rear end surface
53s: side end surface
55p: gas path side surface
55a: counter-gas path side surface
55ab: rear counter-gas path side surface
56: internal passage
56a: auxiliary internal passage
56ao: counter-gas path side opening
56b: main internal passage
56bf: front opening
56io: introduction opening
56bb: rear opening
57: turbulator
66: discharge passage
66o: discharge opening
66a: first discharge passage
66ao: first discharge opening
66b: second discharge passage
66bo: second discharge opening
67: peripheral wall portion
67f: front wall portion
68: hook portion
83: base facing surface
84: base opposite surface
85: introduction opening surface
86: discharge opening surface
86a: first discharge opening surface
86b: second discharge opening surface
91, 92, 93: lid
A: outside air
Acom: compressed air
G: combustion gas
F: fuel
P: base plate
Ar: axis
Da: axial direction
Dau: axial upstream side
Dad: axial downstream side
Dc: circumferential direction
Dr: radial direction
Dri: radial inner side
Dro: radial outer side

1. A method for producing a turbine component, the method comprising:
a printed article forming step of forming a laminate printed article having a plurality of outer surfaces, an internal passage present inside the plurality of outer surfaces, and a discharge passage communicating with the internal passage, by fusing and solidifying a metal powder while distributing the metal powder on a base plate;
a powder removal step of removing a residual powder which is an unnecessary metal powder remaining inside the internal passage;
a heat treatment step of performing heat treatment on the laminate printed article by heating the laminate printed article on the base plate, after the powder removal step;
a plate detachment step of detaching the laminate printed article from the base plate, after the heat treatment step; and
a finishing step of completing the turbine component by using the laminate printed article detached from the base plate,
wherein the internal passage of the laminate printed article formed in the printed article forming step has an introduction opening which is open on an introduction opening surface which is one of outer surfaces excluding a base facing surface which is an outer surface facing the base plate in the plurality of outer surfaces,
the discharge passage of the laminate printed article formed in the printed article forming step has a discharge opening which is open on a discharge opening surface which is at least one of the outer surfaces excluding the base facing surface in the plurality of outer surfaces, and
in the powder removal step, a fluid is introduced into the internal passages from the introduction opening of the internal passage, and the residual powder inside the internal passages is discharged together with the fluid from the discharge opening of the discharge passage.

2. The method for producing a turbine component according to claim 1,
wherein the discharge passage has a discharge opening which is open on each of two outer surfaces excluding the base facing surface in the plurality of outer surfaces, and both the two outer surfaces form the discharge opening surface.

3. The method for producing a turbine component according to claim 1,
wherein in the printed article forming step, a plurality of the discharge passages communicating with the internal passage are formed.

4. The method for producing a turbine component according to claim 3,
wherein a first discharge passage and a second discharge passage in the plurality of discharge passages extend in directions different from each other, and communicate with each other.

5. The method for producing a turbine component according to claim 1,
wherein at least a portion of a surface for defining the internal passage is formed such that undulating shapes are repeated in an extending direction of the internal passage.

6. The method for producing a turbine component according to claim 1,
wherein the internal passage has a main internal passage having the introduction opening which is open on a base opposite surface in a back-to-back relationship with the base facing surface, and an auxiliary internal passage which is open on an outer surface excluding the base facing surface and the base opposite surface in the plurality of outer surfaces, and which communicates with the main internal passage, and
after any one step of the powder removal step, the heat treatment step, and the plate detachment step, an opening closing step of closing the introduction opening which is open on the base opposite surface of the main internal passage is performed.

7. The method for producing a turbine component according to claim 1,
wherein the internal passage extends in a direction having a direction component perpendicular to the base plate, and
the discharge passage extends in a direction having a direction component parallel to the base plate.

8. The method for producing a turbine component according to claim 7,
wherein the discharge passage communicates with the internal passage in an end portion closer to the base plate in the internal passage, and extends along the base plate.

9. The method for producing a turbine component according to claim 8,
wherein the discharge passage is a groove recessed upward from the base facing surface, and extending to the discharge opening surface from a communication position with the internal passage.

10. The method for producing a turbine component according to claim 8,
wherein the discharge passage extends from a communication position with the internal passage to the discharge opening surface in a portion separated upward from the base facing surface, which is a portion closer to the base plate in the laminate printed article.

11. The method for producing a turbine component according to claim 8,
wherein the discharge passage includes a first discharge passage and a second discharge passage,
the first discharge passage is a groove communicating with the internal passage in an end of a side of the base plate of the internal passage, recessed upward from the base facing surface, and extending from a communication position with the internal passage to a first discharge opening surface serving as the discharge opening surface,
the second discharge passage communicates with the internal passage at a portion which is a portion closer to the base plate in the internal passage and which is separated further upward from the base plate than the first discharge passage, and extends from a communication position with the internal passage to a second discharge opening surface serving as the discharge opening surface,
the second discharge opening surface is a surface excluding the base facing surface and the first discharge opening surface in the plurality of outer surfaces, and
both the first discharge opening surface and the second discharge opening surface are connected to an edge of the base facing surface in the plurality of outer surfaces.

12. The method for producing a turbine component according to claim 8,
wherein the finishing step includes a discharge passage forming portion removal step of removing a portion including the base facing surface and the discharge passage in the laminate printed article.

13. The method for producing a turbine component according to claim 1,
wherein after any one step of the powder removal step, the heat treatment step, and the plate detachment step, a discharge opening closing step of closing the discharge opening of the discharge passage is performed.
